(19) United States
(12) Patent Application Publication
(10) Pub. No.: US 2007/0070403 A1
(43) Pub. Date: Mar. 29, 2007

(54) INFORMATION PROCESSING APPARATUS, INFORMATION PROCESSING METHOD, AND PROGRAM

(75) Inventors: Masanari Toda, Tokyo (JP); Takashi Okazawa, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/468,191

(22) Filed: Aug. 29, 2006

(30) Foreign Application Priority Data
Sep. 13, 2005 (JP) 2005-265908

(51) Int. Cl. G06F 3/12

(52) U.S. Cl. 358/1.15; 358/538

(57) ABSTRACT

An information processing apparatus includes a plurality of processing units, an allocation unit configured to allocate data in a plurality of regions included in a print job to the plurality of processing units. The information processing apparatus further includes an output unit configured to output, to a printing apparatus, a plurality of print commands produced by the plurality of processing units subjected to allocation by the allocation unit.

### BACKGROUND OF THE INVENTION

1. Field of the Invention

The present invention relates to an information processing apparatus, an information processing method, and a program. More specifically, the present invention relates to a method for printing by a printing apparatus based on a printing command produced by the information processing apparatus.

b 2. Description of the Related Art

Conventionally, a first method for allowing a printer driver to automatically switch a processing mode is proposed in Japanese Patent No. 3,209,102.

In the first method, a print command received from an operating system (OS) is converted into intermediate data by the printer driver and the intermediate data equivalent to one page is stored. At this time, a performance is calculated, and the processing mode of the print command is switched page by page, band by band, or job by job in accordance with the result of the calculation.

The first method utilizes a high performance of a central processing unit (CPU) of a personal computer. In the first method, with regard to a page constituted by characters and a simple table, highly abstract PDL data is produced by the printer driver, and the PDL data is rasterized into image data by a printer. On the other hand, with respect to a page that includes a rendering command which consumes a relatively large amount of processing capacity of the CPU, a print command is produced by rasterization to image data having low abstractness by the CPU of the personal computer, and then the print command is sent to the printer so as to allow the printer to perform the other processing whose burden to the printer is low.

In addition, a second method has been proposed in which a printing control apparatus analyzes print data input by an information processing apparatus so as to rasterize the print data into bitmap data, which is output to an image forming apparatus serving as a printer engine. Here, the image forming apparatus is, for example, a laser beam printer. The image forming apparatus records an image by allowing laser beams modulated based on the rasterized bitmap data to scan and expose a photoconductive drum.

In addition, the printing control apparatus is capable of outputting data subjected to a WYSIWYG (what you see is what you get) processing performed by the information processing apparatus based on page editing data. In this case, there are two types of printing control apparatuses. Namely, a first type of printing control apparatus receives data produced by the information processing apparatus by rasterizing bitmap data subjected to the WYSIWYG processing into a bitmap memory. A second type of printing control apparatus receives data to be rasterized from the information processing apparatus. In the second type, the printing control apparatus performs rasterization processing on the received data to produce bitmap data, and then rasterizes the bitmap data into a bitmap memory to output the rasterized data.

However, in the first type of printing control apparatus in the second method described above, the time from the start of the rasterization of the bitmap data by the information processing apparatus to the start of printing processing by the printer engine is determined depending on the time for rasterization processing by the information processing apparatus.

In addition, in the second type of printing control apparatus, the time required for transmission of the data from the information processing apparatus to the printing control apparatus is relatively short. However, a longer time period may be required for rasterization processing by the printing control apparatus. Thus, an image writing synchronicity with the printer engine may be shifted, and accordingly, the received data may not be correctly recorded.

In this regard, as a countermeasure to the drawback of the second method, Japanese Patent Application Laid-Open No. 11-316663 discusses a third method such that the data to be converted by the printer and the data previously converted are selectively sorted on the basis of capacity information of the printer obtained from the printer so as to transfer the sorted data to the printer.

Meanwhile, the time required for producing the print data having low abstractness is longer than the time required for producing the print data having high abstractness. However, in the conventional method described above, if a page (region) in which the print data having low abstractness is produced exists in a print job including a plurality of pages, the transfer of the print data to the printer is congested during the production of the print data. That is, while the print data is not sent to the printer, a communication path and a printer resource are not effectively utilized, and thus the entire processing is not optimized.

Such drawback more or less exists regardless of the switching of the processing mode. That is, if one of the pages included in a print job has an extremely different processing load characteristic compared to other pages in the print job, the resource of the information processing apparatus (e.g., personal computer) that issues the print command to the printer and the resource of the printer are not likely to be effectively and sufficiently used.

As described above, in the conventional methods, if a print job includes data and/or commands that consume a relatively large amount of processing capacity, the throughput for the print job can be lowered.

### SUMMARY OF THE INVENTION

At least one embodiment of the present invention is directed to improving the throughput for a print job that includes a region whose processing load is high.

According to an aspect of the present invention, an information processing apparatus includes a plurality of processing units; an allocation unit configured to allocate data in a plurality of regions included in a print job to the plurality of processing units; and an output unit configured to output, to a printing apparatus, a plurality of print commands produced by the plurality of processing units subjected to allocation by the allocation unit.

According to another aspect of the present invention, a method for execution in an information processing apparatus having a plurality of processing units, includes allocating data in a plurality of regions included in a print job to the plurality of processing units; and outputting, to a printing apparatus, a plurality of print commands produced by the plurality of processing units.

According to yet another aspect of the present invention, a computer-readable storage medium storing instructions which, when executed by a computer, causes the computer to perform operations includes allocating data in a plurality of regions included in a print job to the plurality of processing units; and outputting, to a printing apparatus, a plurality of print commands produced by the plurality of processing units.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a diagram illustrating an example of a configuration of an image forming system to which embodiments of the present invention can be applied.

FIG. 2 is a block diagram illustrating an example of an inner configuration of an information processing apparatus and a printer according to an embodiment of the present invention.

FIG. 3 is a diagram illustrating an example of a configuration of a printer engine provided to the printer according to the first embodiment of the present invention.

FIG. 4 is a diagram illustrating an example of a memory map in a state in which a print-related module including a printer control program is loaded to a RAM of the information processing apparatus so as to be executable according to the first embodiment of the present invention.

FIG. 5 is a diagram illustrating an example of a configuration of a typical print processing by the information processing apparatus according to the first embodiment of the present invention.

FIG. 6 is a diagram illustrating an example of a configuration of the print processing by the information processing apparatus according to the first embodiment of the present invention, including characteristic portions.

FIG. 7 is a flow chart illustrating an example of an outline of the processing by a printer control program according to the first embodiment of the present invention.

FIG. 8 is a flow chart illustrating a detailed processing in step S401 in FIG. 7 according to the first embodiment of the present invention.

FIG. 9 is a diagram illustrating an example of a job identifier according to the first embodiment of the present invention.

FIG. 10 is a diagram illustrating an example of a content of a spool file produced in an HD drive by the processing in step S401 in FIG. 7 according to the first embodiment of the present invention.

FIG. 11 is a flow chart illustrating an example of the processing by a spool file manager that receives a file name of a spooled spool file and intermediate command information recorded to the job identifier according to the first embodiment of the present invention.

FIG. 12 is a flow chart illustrating an example of a processing executed by a PDL processor in producing a print data file from an intermediate command that is temporarily stored in the spool file according to the first embodiment of the present invention.

FIG. 13 is a diagram illustrating a specific example of the print data that a PDL processor produces according to the first embodiment of the present invention

FIG. 14 is a flow chart illustrating an example of a processing executed by an output manager according to the first embodiment of the present invention.

FIG. 15 is a diagram illustrating a specific example of the print data whose page number is transposed according to the first embodiment of the present invention.

FIG. 16 is a block diagram illustrating an example of an inner configuration of a printer that is capable of processing the print data whose page number is transposed according to the first embodiment of the present invention.

FIG. 17 is a flow chart illustrating an example of a processing executed by a translator according to the first embodiment of the present invention.

FIG. 18 is a flow chart illustrating an example of a processing executed by a renderer according to the first embodiment of the present invention.

FIGS. 19A and 19B are schematic diagrams illustrating an example of a configuration of a page management table according to the first embodiment of the present invention.

FIGS. 20A and 20B are diagrams illustrating the processing time in the case of processing by a conventional single thread and the processing time in the case of processing by multi-thread (two threads including a thread corresponding to odd-numbered pages and a thread corresponding to even-numbered pages) according to the first embodiment.

FIGS. 21A and 21B are diagrams illustrating the processing time in the case of processing by the conventional single thread and the processing time in the case of the multi-thread (two threads including a thread for a low processing load page and a thread for a high processing load page) according to the first embodiment.

FIG. 22 is a diagram illustrating an example of a configuration of a print processing by the information processing apparatus according to a second embodiment of the present invention.

FIG. 23 is a block diagram illustrating an example of a configuration of an information processing apparatus according to a third embodiment of the present invention.

FIG. 24 is a block diagram illustrating an example of a configuration of a printing control apparatus according to the third embodiment of the present invention.

FIG. 25 is a block diagram illustrating an example of a functional configuration of the information processing apparatus and the printing control apparatus according to the third embodiment of the present invention.

FIG. 26 is a flow chart illustrating an example of a processing by a printer driver in the information processing apparatus according to the third embodiment of the present invention.

FIG. 27 is a flow chart illustrating an example of a processing by a network interface in the printing control apparatus according to the third embodiment of the present invention.

FIG. 28 is a flow chart illustrating an example of a processing by the printing control apparatus according to the third embodiment of the present invention.

### DETAILED DESCRIPTION OF THE EMBODIMENTS

Exemplary embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

First Exemplary Embodiment

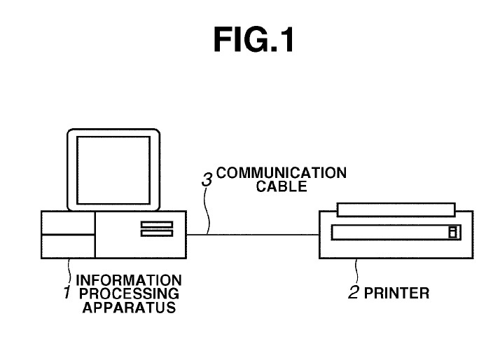

FIG. 1 is a diagram illustrating an example of a configuration of an image forming system to which embodiments of the present invention can be applied.

Referring to FIG. 1, in the image forming system, an information processing apparatus 1 and a printer 2 are mutually connected via a communication cable 3 connected to a Centronics interface (I/F).

It is noted that in reference to the system illustrated in FIG. 1, the description is made as to a case where the information processing apparatus 1 and the printer 2 are mutually connected one to one, for a simple understanding. However, it is noted that the features of embodiments described below can be implemented in a system that includes a plurality of the information processing apparatuses 1 and/or a plurality of the printers 2. In addition, the information processing apparatus 1 and the printer 2 can be connected to each other via a network such as a LAN and a WAN.

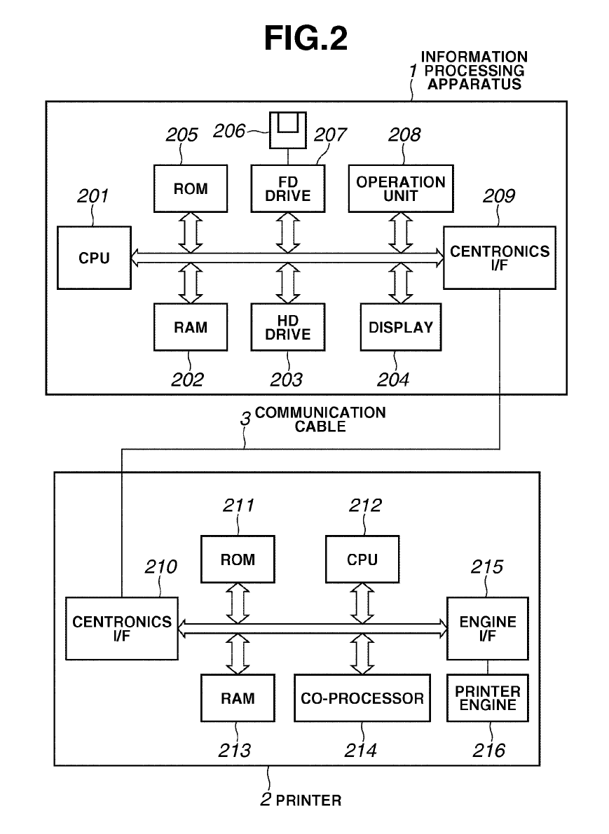

FIG. 2 is a block diagram illustrating an example of an inner configuration of the information processing apparatus 1 and the printer 2.

First, the inner configuration of the information processing apparatus 1 is described.

A CPU 201 controls the information processing apparatus 1 by executing a control program. A RAM 202 functions as a main memory of the CPU 201 and a work area in executing an operating system (OS) and an application program.

An HD drive 203 stores a printer control program. A display 204 displays the data and a result of a processing. The display 204 is, for example, a CRT display or a liquid crystal display. A ROM 205 stores various kinds of programs including a program for performing a processing on a document; fonts; and various kinds of data such as template data, for example.

A flexible disk (FD) 206 stores a printer driver and a processing mode automatic control program. An FD drive 207 outputs the program and the data stored in the FD 206 to the RAM 202 and the HD drive 203. An operation unit 208 is a user interface that includes a keyboard and a pointing device, for example. A Centronics I/F 209 is a communication interface for communication with an external device such as the printer 2.

Note that in the example in FIG. 2, one CPU 201 is provided. However, the configuration may be such that physically a plurality of CPUs are provided or that a plurality of cores are provided in one CPU so as to virtually provide a plurality of CPUs so that the OS allocates threads to the plurality of CPUs.

The CPU 201 performs a processing for rasterizing (rasterization processing) outline fonts to a display information RAM that is set to the RAM 202 and allows a WYSIWYG display by the display 204. In addition, the CPU 201, in accordance with a command instructed with a mouse cursor that is displayed by the display 204, opens various kinds of windows that are previously registered so as to perform various data processings. In performing printing by the printer 2, a user opens a window related to settings for the printing so as to perform the settings for the printer 2 and a setting for a method for print processing with respect to the printer driver including a selection of the print mode.

Next, an example of the inner configuration of the printer 2 is described. A Centronics interface (I/F) 210 is a communication interface for communicating with an external device such as the information processing apparatus 1. For example, the Centronics I/F 210 allows the printer 2 to receive the print data from the information processing apparatus 1 via the communication cable 3. A ROM 211 stores various kinds of control programs such as a mode switching control program.

A CPU 212 controls over accesses between the printer 2 and each device by executing the control program stored in the ROM 211 and outputs an image signal which is output information to a printer engine 216 via an engine I/F 215. A RAM 213 functions as a main memory of the CPU 212 and a work area.

A co-processor 214 performs a simple calculation. The printer engine 216 actually conveys paper sheets and performs the printing. The engine I/F 215 is an interface of the printer engine 216 with each unit provided in the printer 2.

The printer 2 according to the first embodiment includes a full color mode and a monochromatic mode as the processing mode. In addition, the printer 2 according to the first embodiment is capable of switching the processing mode page by page based on the print data in accordance with control information input by the information processing apparatus 1, which is a host computer, as described below.

Note that the communication cable 3 can be substituted with a network. In this case, the Centronics I/F 209 and the Centronics I/F 210 are substituted with a network I/F or a network board.

The CPU 212 allows a communication between the printer 2 and the information processing apparatus 1, which is a host computer, via the Centronics I/F 210. The CPU 212 can notify information of the printer 2 to the information processing apparatus 1. The RAM 213 is configured so that a memory capacity can be expanded by an option RAM connected to an expansion port. Note that the RAM 213 is used for an output information rasterization region, an environmental data storing region, and an NVRAM, for example.

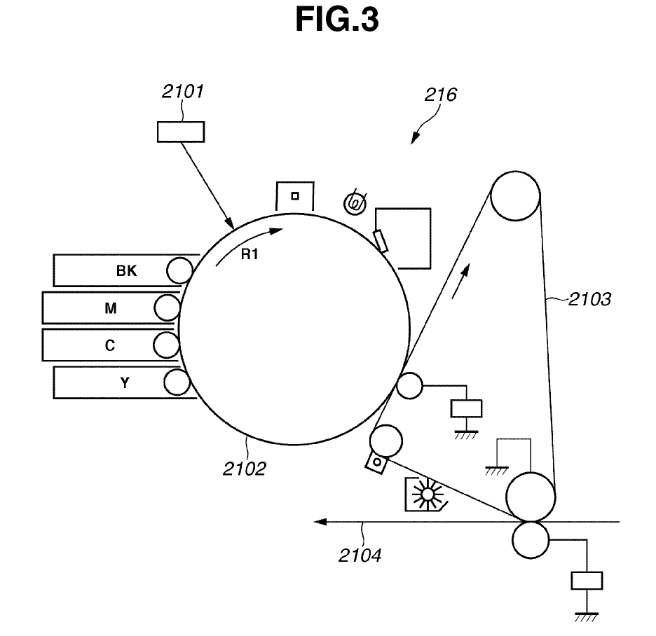

FIG. 3 is a diagram illustrating an example of a configuration of the printer engine 216 provided to the printer 2.

A laser beam modulated with image data of each color that is obtained based on the image signal input via the engine I/F 215 is allowed to scan a photoconductive drum 2102 by a polygonal mirror 2101 so as to form an electrostatic latent image. Then, the latent image is developed with toner so as to obtain a visible image. Then, when all the colors of the visible image are multiple-transferred to an intermediate transfer member 2103, a color visible image is formed. In addition, the color visible image is transferred to a transfer member 2104, and then the color visible image is fixed onto the transfer member 2104.

An image forming unit that performs the above control includes a drum unit having the photoconductive drum 2102; a primary charging unit having a contact charging roller; a cleaning unit; a developing unit; the intermediate transfer member 2103; a paper feed unit including a paper cassette and various rollers; a transfer unit including a transfer roller; and a fixing unit.

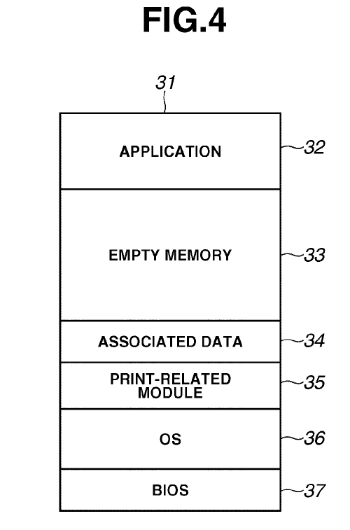

FIG. 4 is a diagram illustrating an example of a memory map in a state where a print-related module including the printer control program is loaded to the RAM 202 of the information processing apparatus 1 so as to be made executable.

Referring to FIG. 4, a memory map 31 includes an application program 32, an empty memory 33, associated data 34, a print-related module 35 including the printer control program, an OS 36, and a basic input/output system (BIOS) 37.

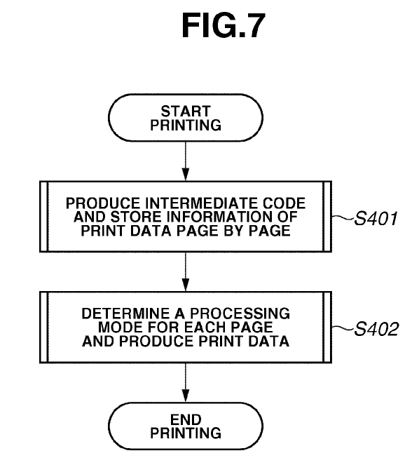

Note that the processing mode automatic control program that executes the commands described in each step in FIGS. 7, 8, 11, 12, and 14 is stored as a part of the print-related module including the printer control program that is stored in the HD drive 203 at the time of execution thereof. The CPU 201 executes the processing mode automatic control program under the management of the OS 36.

The information processing apparatus 1 according to the first embodiment operates by the execution by the CPU 201 of the BIOS 37, the OS 36, the print-related module 35 including the printer control program, and the application program 32. The BIOS 37 is written in the ROM 205, and the OS 36 is written in the HD drive 203. When the information processing apparatus 1 is turned on, the OS 36 is read from the HD drive 203 to the RAM 202 by an initial program loading (IPL) function in the BIOS 37, and thus the OS 36 is activated.

In addition, when a print processing is executed by an application program that operates under the management of the OS 36 in accordance with an instruction by a user, the print-related module 35 including the printer control program becomes actually operable.

That is, the print-related module 35 including the printer control program becomes actually operable when the FD 206 in which the print-related module 35 is stored is set to the FD drive 207 and the print-related module 35 is read from the FD 206 or the HD drive 203 under the control of the OS 36 and the BIOS 37 and is loaded to the RAM 202.

Alternatively, the print-related module 35 including the printer control program becomes actually operable when the print-related module 35 is stored in the HD drive 203 and the print-related module 35 is read from the FD 206 or the HD drive 203 under the control of the OS 36 and the BIOS 37 and is loaded to the RAM 202.

As described above, FIG. 4 illustrates the memory map 31 in a state where the print-related module 35 including the printer control program is loaded to the RAM 202 of the information processing apparatus 1 so as to be executable.

Note that the printer control program may be stored in the ROM 205 of the information processing apparatus 1. In addition, program code of the printer control program may be installed from the FD 206 to the information processing apparatus 1 via the FD drive 207.

In addition, the storage medium that stores the above program is not limited to the FD 206. That is, a CD-ROM, a CD-R, a magneto-optical disk, an optical disk, a magnetic tape, a non-volatile memory card, or a DVD may be used.

In this case, the program code itself, which is read from the storage medium, implements the functions of the embodiment mentioned above, and accordingly, the storage medium storing the program code constitutes the present invention.

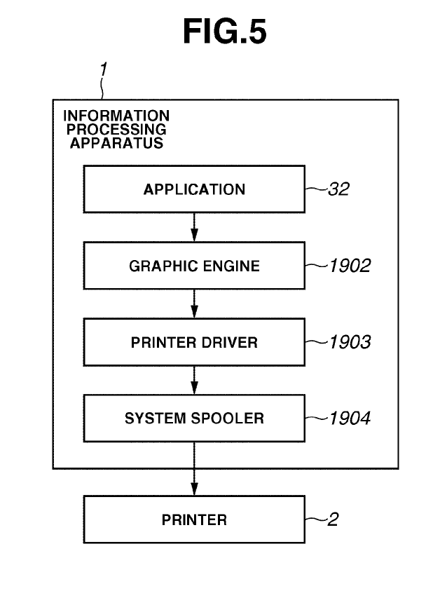

FIG. 5 is a diagram illustrating an example of a configuration of a typical print processing by the information processing apparatus 1 mutually connected to the printer 2.

Referring to FIG. 5, the application program 32, a graphic engine 1902, a printer driver 1903, and a system spooler 1904 exist as a file stored in the HD drive 203, respectively.

Each of the application program 32, the graphic engine 1902, the printer driver 1903, and the system spooler 1904 is a program module that is loaded to the RAM 202 and executed by the OS 36. Note that the application program 32 and the printer driver 1903 may be stored in the FD 206 or another storage medium such as a CD-ROM.

In addition, the application program 32 and the printer driver 1903 can be added to the HD drive 203 via the network.

The application program 32 is loaded to the RAM 202 so as to be executed. However, in instructing the printer 2 from the application program 32 to perform the printing, an output (rendering) is performed by utilizing the graphic engine 1902 that is loaded to the RAM 202 and executable.

The graphic engine 1902 sends a printing command to the printer driver 1903 that is provided for each printer 2 and allows the print data produced by the application program 32 to be converted into a control command to the printer 2 by using the printer driver 1903. The printer control command is output to the printer 2 via the system spooler 1904 that is loaded to the RAM 202 by the OS 36 and via the Centronics I/F 209.

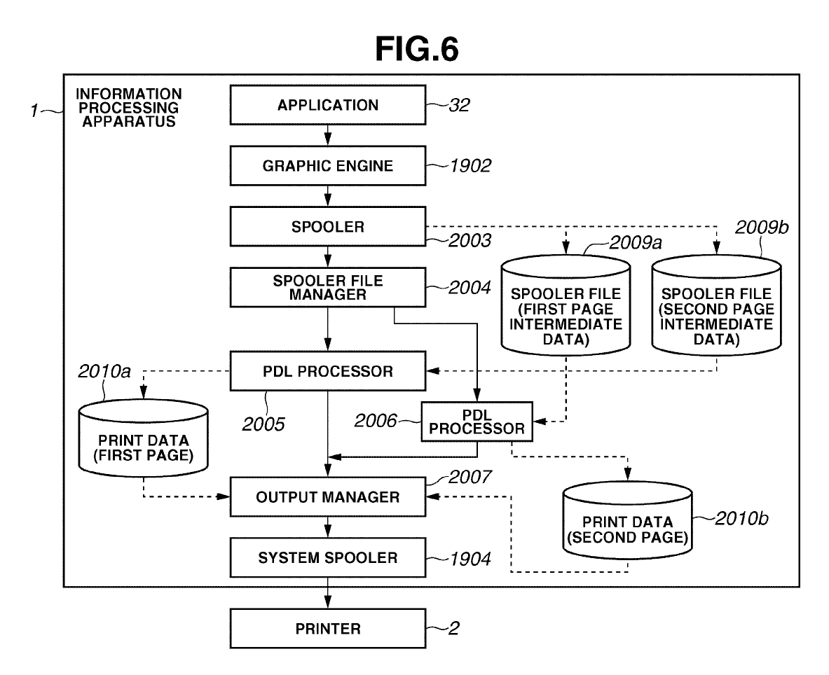

In addition to the configuration shown in FIG. 5, in the image forming system according to the first embodiment, the print data produced by the application program 32 is temporarily spooled as intermediated code data as shown in FIG. 6.

FIG. 6 is a diagram illustrating an example of the configuration of the print processing by the information processing apparatus 1 mutually connected to the printer 2, including a characteristic portion.

As shown in FIG. 6, in the information processing apparatus 1 according to the first embodiment, a spool file 2009 constituted by an intermediate code is temporarily produced when the print command is sent from the graphic engine 1902 to the printer driver 1903.

By temporarily producing the spool file 2009 in this manner, when the print command is being spooled by a spooler 2003, a processing mode that is optimum for producing the print command can be selected by confirming the content of the print command. For example, a process of the application program 32 and a process of a print processor that produces the print data can be distinguished.

As shown in FIG. 6, in the first embodiment, the print command from the graphic engine 1902 is received by the spooler 2003, not by the printer driver 1903. The CPU 201 loads the spooler 2003 that is stored in the HD drive 203 to the RAM 202. The print command is sent to the spooler 2003 that is loaded to the RAM 202.

The spooler 2003 converts the received print command into an intermediate code and outputs the intermediate code in the form of a spool file 2009. In the first embodiment, the spool file 2009 is produced page by page. When the print command is spooled to the spool file 2009, information such as the kind and the size of the data is counted up. In addition, the spool file 2009 stores page hint information.

Note that in the fist embodiment, the spool file 2009 is produced as a file in the HD drive 203. However, the spool file 2009 maybe produced in the RAM 202. In addition, the spool file 2009 may be produced band by band.

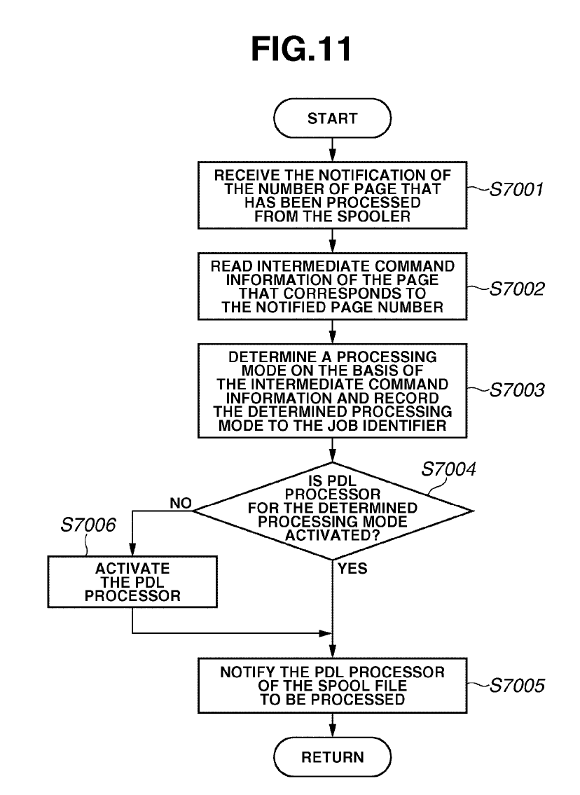

The spooler 2003 loads a spool file manager 2004 that is stored in the HD drive 203 to the RAM 202, and then notifies a status of production of the spool file 2009 to the spool file manager 2004. When the spool file 2009 for one page is produced, the spool file manager 2004 determines the processing mode on the basis of the page hint information stored in the spool file 2009. A specific example of the method of determining the processing mode is described in detail in step S7003 in a flow chart of FIG. 11.

The spool file manager 2004 reads from the HD drive 203 PDL processors 2005 and 2006 corresponding to the determined processing mode and loads the PDL processors 2005 and 2006 to the RAM 202.

Then, the spool file manager 2004 instructs the PDL processor 2005 and the PDL processor 2006 to perform the printing processing of the intermediate code described in the spool file 2009.

In the above example, the spool file manager 2004 instructs the PDL processor 2005 to perform the print processing of the intermediate code that is described in the spool file 2009 which is classified as a page that needs a light processing (a page having a high abstractness).

On the other hand, the spool file manager 2004 instructs the PDL processor 2006 to perform the print processing of the intermediate code that is described in the spool file 2009 which is classified as a page that needs a heavy processing (a page having a low abstractness).

Each of the PDL processor 2005 and the PDL processor 2006 operates in mutually different processes or threads. In the first embodiment, the PDL processor 2005 is a module that produces a print data file 2010 that is related to a page description language (PDL) having a high abstractness (namely, a PDL command having a high abstractness). In addition, the PDL processor 2006 is a module that produces a print data file 2010 that is related to the intermediate data having a low abstractness (including an image mode) (namely, the PDL command that is converted into a primitive rendering command).

Each of the PDL processor 2005 and the PDL processor 2006 produces the print data file 2010 for one page by processing the spool file 2009 instructed from the spool file manager 2004.

In the example shown in FIG. 6, a spool file 2009ahas a high abstractness, and accordingly, the PDL processor 2005 produces a print data file 2010a for one page by processing the spool file 2009a.

On the other hand, a spool file 2009b has a low abstractness, and accordingly, the PDL processor 2006 produces a print data file 2010b for one page by processing the spool file 2009b.

Note that in the first embodiment, the print data file 2010 is produced in the HD drive 203 as a file. However, the print data file 2010 may be produced in the RAM 202.

The PDL processor 2005 and the PDL processor 2006, upon production of the print data file 2010 for one page, immediately output the print data file 2010 to an output manager 2007 that operates in a different process. The output manager 2007 outputs the received print data file 2010 to the printer 2 via the system spooler 1904.

FIG. 7 is a flow chart illustrating an example of an outline of a processing by the printer control program.

First, in step S401, the CPU 201 converts the print data (for example, code data) received from the application program 32 at the time of printing into the intermediate code and temporarily stores the intermediate code in the HD drive 203.

In addition to the production and storing of the intermediate code, the CPU 201 stores the information of each print data to which a print request is made from the application program 32 in the RAM 202, and stores the information page by page.

Then, in step S402, the CPU 201 determines the processing mode for producing the print data, in accordance with the intermediate code that is temporarily stored in step S401 and the page-by-page information that is stored in the RAM 202 in step S401.

The CPU 201 produces the print data file 2010 to output to the printer 2 in the determined processing mode.

Note that the image forming system can be implemented without producing the intermediate code as described above.

For example, the configuration may be such that the CPU 201, in producing code data that is the print data, analyses once the code data so as to perform a statistical analysis on each kind of data per page of the print data. Then, after producing the print data file for one page, the CPU 201 again produces the code data from the analyzed code data.

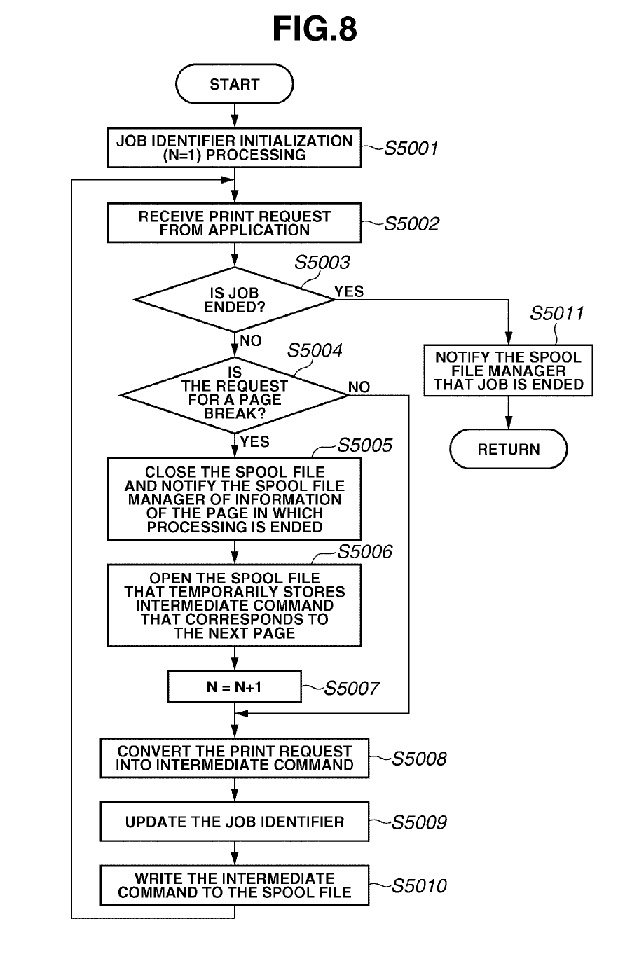

FIG. 8 is a flow chart illustrating a detailed processing of step S401 shown in FIG. 7. Note that the processing shown in FIG. 8 is performed by the CPU 201 when the spooler 2003 produces the spool file 2009.

A job initialization processing as described below is performed in step S5001.

In the job initialization processing, first, the spool file 2009 for temporarily storing the intermediate code and a job identifier for identifying a job are produced in the HD drive 203 of the information processing apparatus 1, and then the produced spool file 2009 is opened.

Then, the job identifier is initialized in order to store the information of the intermediate code page by page, and then the job identifier is notified to the spool file manager 2004.

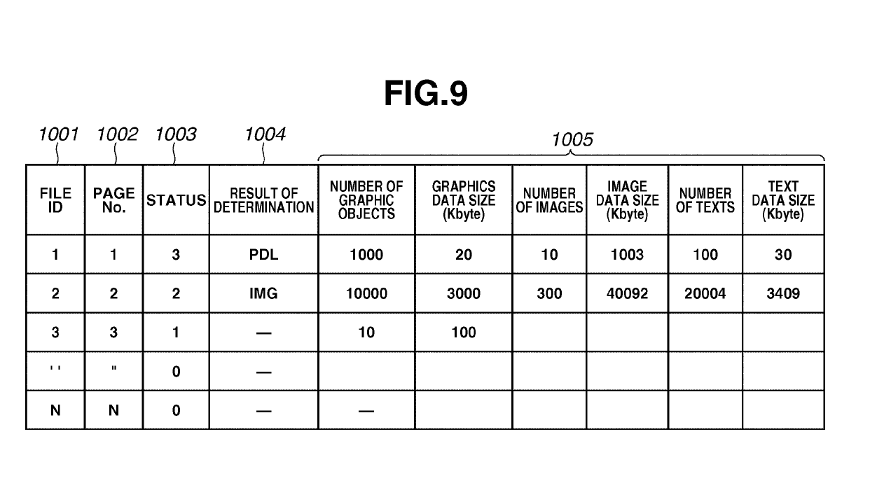

FIG. 9 is a diagram illustrating an example of the job identifier.

Referring to FIG. 9, the job identifier includes a file ID 1001, a page number 1002, a status 1003, a result of determination 1004, and intermediate command information 1005, for each page.

The file ID 1001 is the information for identifying the spool file 2009 in which the intermediate code is stored. The page number 1002 is the information that indicates a page order received from the OS 36. The status 1003 is the information for managing a status of the printer 2. The result of determination 1004 is the information that indicates the determined processing mode. The intermediate command information 1005 is the information related to the stored intermediate command.

In the job initialization processing, all the job identifiers are cleared. More specifically, for example, a page counter N that is stored in the file ID 1001 of a member is set to “1”. In addition, the status 1003 is changed to “1” that indicates that the job is being spooled. Thus, it is indicated that a first page is being processed.

Referring back to FIG. 8, next, in step S5002, a print request from the application program 32 is received.

Then, in step S5003, it is determined whether or not the print request received in step S5002 is an end of the job. If the received print request is determined to be the request for the end of the job (“Yes” in step S5003), the processing advances to step S5011 described below. On the other hand, if the received print request is not the end of the job (“No” in step S5003), the processing advances to step S5004 where it is determined whether or not the print request received in step S5002 is for a page break. If the received print request is not for the page break (“No” in step S5004), the processing skips steps S5005 through S5007 and advances to step S5008. On the other hand, if the received print request is for the page break (“Yes” in step S5004), the processing advances to step S5005.

In step S5008, the received print request (print data) is converted into intermediate command. Then, in step S5009, intermediate command information 1005 related to the intermediate command produced in step S5008 is reflected to the job identifier.

Next, in step S5010, the intermediate command is written to the spool file 2009 in the HD drive 203.

Then, the processing returns to step S5002 and again receives the print request from the application program 32. The processing in steps S5002 through S5010 is repeated until the print request for ending the job is received from the application program 32.

If the print request received in step S5002 is determined to be the request for the page break in step S5004, the processing advances to step S5005 and the spool file 2009 that is open is closed.

Then, a value of the status 1003 of the job identifier is changed to “2” that indicates an end of spooling of the data.

After that, the information of the page whose processing is ended is notified to the spool file manager 2004 so as to transfer the processing of the page to the spool file manager 2004.

The page information notified to the spool file manager 2004 includes, for example, a file name of the spool file 2009 that temporarily stores the produced intermediate command and the intermediate command information 1005 that is recorded in the job identifier.

Then, in step S5006, the spool file 2009 for temporarily storing the intermediate command corresponding to the next page is opened.

Then, in step S5007, the page counter N used for the job identifier is incremented, and then the processing advances to step S5008.

If the print request received in step S5002 is determined to be the request for ending the job in step S5003, all the print requests from the application program 32 are completed, and the processing advances to step S5011. Then, in step S5011, a progress of the print processing is notified to the spool file manager 2004 and the processing of step S401 in FIG. 7 ends.

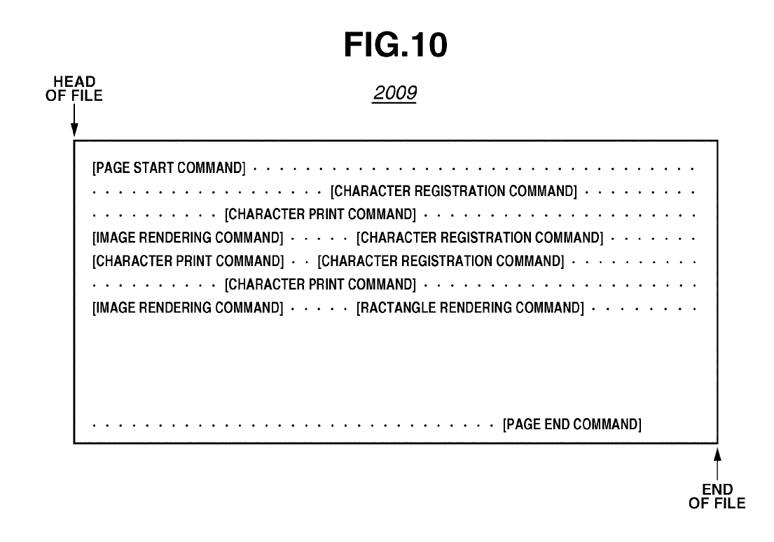

FIG. 10 is a diagram illustrating an example of a content of the spool file 2009 produced in the HD drive 203 by the processing in step S401 in FIG. 7. Note that in FIG. 10, “page start command”, “character registration command”, “character print command”, and the like are described. However, these descriptions are made for a simple understanding of the print data in the file, and the descriptions may actually be made in a binary form.

FIG. 11 is a diagram illustrating an example of the processing by the spool file manager (a process or a thread) 2004 that receives a file name of the spool file 2009 that is already spooled and the intermediate command information 1005 that is recorded in the job identifier. First, in step S7001, a page number of the page that is already spooled is notified, and in step S7002, the intermediate command information 1005 that corresponds to the page number is read.

Then, in step S7003, the processing mode that is most suitable for processing the page is determined on the basis of the value of the intermediate command information 1005 that is read in step S7002, and then the determined processing mode is recorded in the result of determination 1004 of the job identifier.

In the first embodiment, the processing mode that is to be switched includes, for example, a PDL mode for sending a PDL command having high abstractness and an image mode for sending a command having low abstractness. By switching between the processing modes, an overall processing speed can be improved.

In this regard, for example, both the time required for processing in the PDL mode and the time required for processing in the image mode are estimated based on the number of rendering commanding elements (the number of graphic objects) of the intermediate command recorded in the job identifier and the graphics data size. Then, one of the processing modes is determined to be a shorter one based on the respective estimated processing time.

In accordance with an embodiment, if the page does not have many rendering commands and does not exceed the processing capacity of the printer 2, the PDL mode is desirable, because in the PDL mode, the PDL command is produced with highly abstract print data. Therefore, by selecting the PDL mode, the size of the print data to be transferred can be reduced and the time required for producing the print data can be suppressed to a minimum.

On the other hand, if image data of a huge size or the print data of the page including a command for rendering complicated graphics is converted into PDL and sent to the printer 2, the size of the print data can exceed the processing capacity of the printer 2. Recently, in the information processing apparatus 1, a CPU having a processing capacity higher than the printer 2 is generally used. Therefore, the total time taken for the processing can be shortened by rasterizing the data to a command having low abstractness by the information processing apparatus 1 (most extremely, to the image data of the whole page).

In step S7004, whether the PDL processor 2005 and the PDL processor 2006 that are suitable to the processing mode determined in step S7003 are already activated is determined. If it is determined as a result of the determination that the PDL processor 2005 and the PDL processor 2006 that are suitable to the determined processing mode are not activated (“No” in step S7004), the processing advances to step S7006 and the PDL processor 2005 and the PDL processor 2006 that are suitable to the determined processing mode are not activated. On the other hand, if the PDL processor 2005 and the PDL processor 2006 that are suitable to the determined processing mode are already activated (“Yes” in step S7004), the processing skips step S7006 and advances to step S7005.

Then, in step S7005, a notification to the effect that the spool file 2009 be processed is made to the PDL processor 2005 and the PDL processor 2006 that are activated.

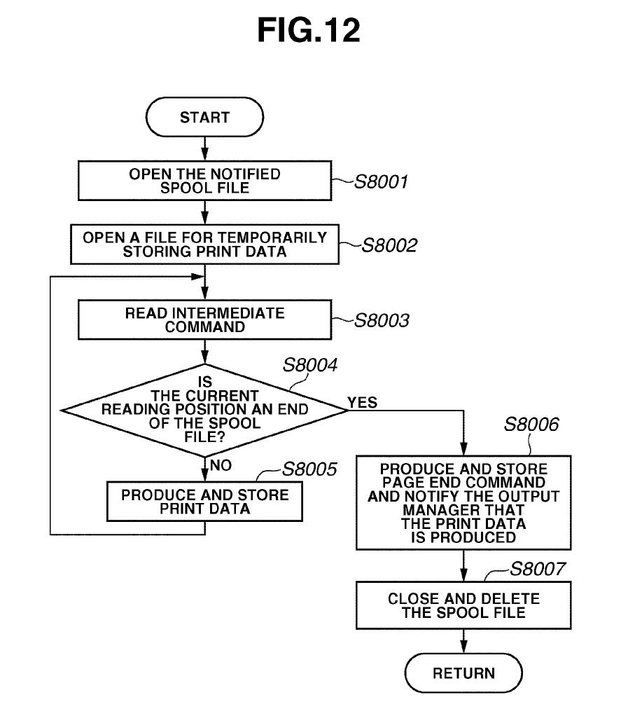

FIG. 12 is a diagram illustrating an example of a processing executed by the PDL processor 2005 and the PDL processor 2006 in producing the print data file 2010 from the intermediate command that is temporarily stored in the spool file 2009.

First, in step S8001, the job identifier that is stored in the HD drive 203 is scanned so as to retrieve the page to which the processor is to perform the processing. For example, if the activated PDL processor is the PDL processor 2005 for the PDL mode, then the status 1003 is “2”, and the file ID 1001 whose result of determination 1004 is set to PDL is retrieved. Then, the spool file 2009 that corresponds to the retrieved file ID 1001 is opened.

Next, in step S8002, the print data file 2010 in which the print data to be produced is temporarily stored is opened. A storing destination of the print data may be the HD drive 203 or an area in which the associated data 34 of the RAM 202 is stored. Then, area information by which a position in a job (page position) can be read is added to the print data file 2010 that is opened.

Then, the retrieval of the intermediate command is actually started. First, in step S8003, the intermediate command is read per each print command as shown in FIG. 10. The intermediate command that is first read from the intermediate commands temporarily stored in the spool file 2009 shown in FIG. 10 is “page start command”. Successively, the intermediate commands are read to an end (tail end) of the spool file 2009.

In the course of reading the intermediate command, in step S8004, the CPU 201 determines whether a current reading position is an end of the spool file 2009. If it is determined that the current reading position is not the end of the spool file 2009 (“No” in step S8004), the processing advances to step S8005 where the CPU 201 produces the print data from the intermediate command in accordance with the specified processing mode. Then, the produced print data is stored in the print data file 2010 opened in step S8002.

If it is determined that the current reading position is the end of the spool file 2009 (“Yes” in step S8004), the processing proceeds to step S8006. In step S8006, a page end command is produced, and the produced page end command is added to the file in which the print data is stored in step S8005. Then, the status 1003 of the job identifier is set to “3” which indicates the end of the processing, and then the page number of the page whose print data is produced and the stored print data are notified to the output manager 2007.

Then, in step S8007, the spool file 2009 in which the intermediate command whose print data is completely produced is temporarily stored is closed and deleted.

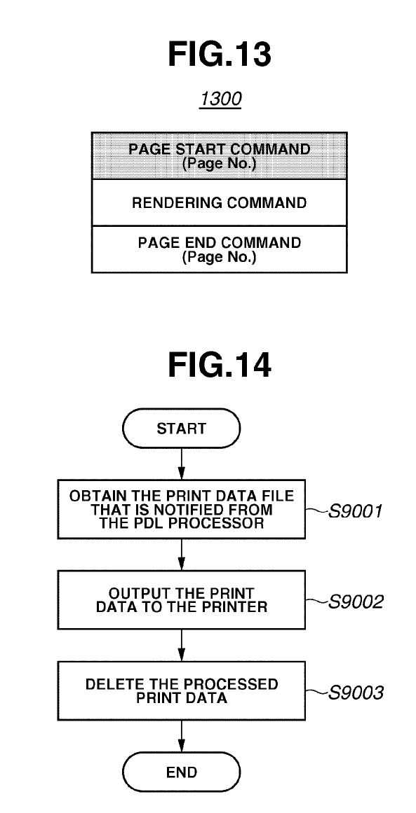

FIG. 13 illustrates a specific example of the print data that the PDL processors 2005 and 2006 produce in steps S8002 through S8005. Print data 1300 shown in FIG. 13 indicates the page position in the job by assigning an original page number received from the application program 32 as an attribute of a page start command and an attribute of a page end command.

FIG. 14 is a flow chart illustrating an example of a processing executed by the output manager 2007 (the CPU 201), which is a final processing by the printer driver.

First, in step S9001, when a notification of the end of production of the print data for one page by the PDL processor 2005 and the PDL processor 2006 is received, the job identifier in the HD drive 203 is scanned, and then the page that can be output to the printer 2 is retrieved. In the example shown in FIG. 9, if the status 1003 is set to “3”, the conversion from the intermediate command into the print data is completed. Accordingly, a page having a smallest page number 1002 from among pages whose status 1003 is “3” is selected. Then, the print data file 2010 of that page is obtained.

Next, in step S9002, the print data included in the print data file 2010 that is obtained in step S9001 is output to the printer 2 via the system spooler 1904. Then, “4” which indicates that all the processings are completed is recorded in the status 1003 of the job identifier.

Next, in step S9003, the print data file 2010 having the print data that has been output to the printer 2 is deleted.

As described above, the output manager 2007 receives the print data produced by the PDL processor 2005 and the PDL processor 2006 page by page, and immediately after that, outputs the print data to the printer 2. In this regard, if a plurality of the PDL processor 2005 and the PDL processor 2006 produce print data in separate threads in parallel, a page that needs a relatively long period of time for processing can be overtaken by a page that needs a relatively short period of time for processing so as to be output to the printer 2.

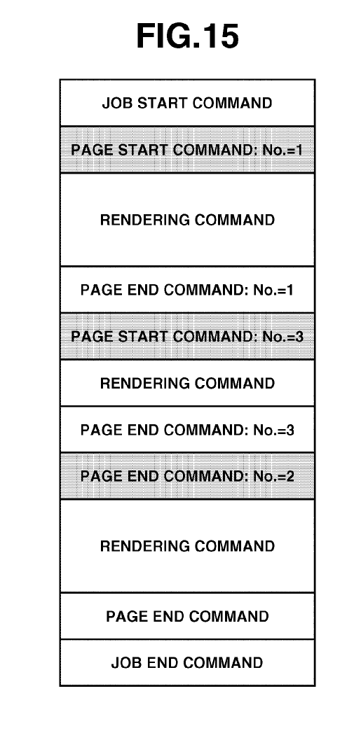

In this case, the page numbers of the print data that the printer 2 receives are transposed as shown in FIG. 15. However, because the rendering command is interposed between the page start command and the page end command, the order of pages for outputting by the printer 2 can be rearranged. Note that in the case of a PDL command form in which the rendering command is sent band by band, the order of sending band by band can be changed by adding a “page number” and a “band number” to the rendering command.

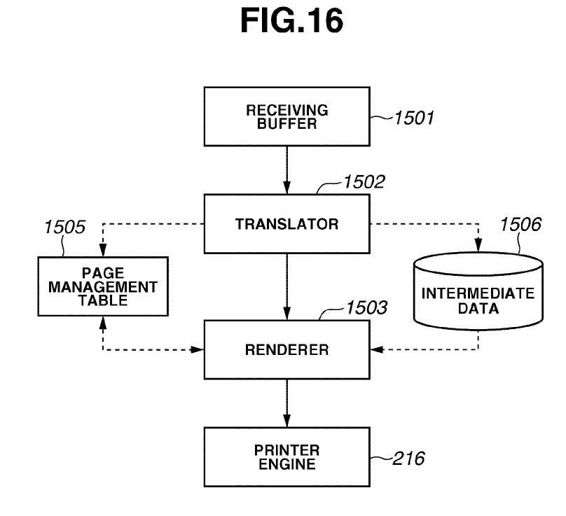

FIG. 16 is a block diagram illustrating an example of an inner configuration of the printer 2, which is capable of processing the print data whose page order is transposed as shown in FIG. 15.

Referring to FIG. 16, the PDL command stored in a receiving buffer 1501 is converted into intermediate data 1506 by a translator 1502, which is a program that operates on the CPU 212. After that, the intermediate data 1506 is managed page by page in the RAM 213. More specifically, each page of the intermediate data 1506 is recorded in a page management table 1505, which is produced in the RAM 213. The page management table 1505 is transferred to a renderer 1503.

The renderer 1503 is a module for allowing a program that operates on the CPU 212 to produce image data from the intermediate data by using hardware. The renderer 1503 determines whether an outputable page is present by referring to the page management table 1505 transferred from the translator 1502. If the outputable page is present, the intermediate data 1506 is read and a processing for rasterizing the intermediate data 1506 into image data is performed. The image data rasterized to the RAM 213 is converted into a video signal. The video signal is then sent to the printer engine 216, and then the print processing ends. The page on which print processing is completed is recorded in the page management table 1505.

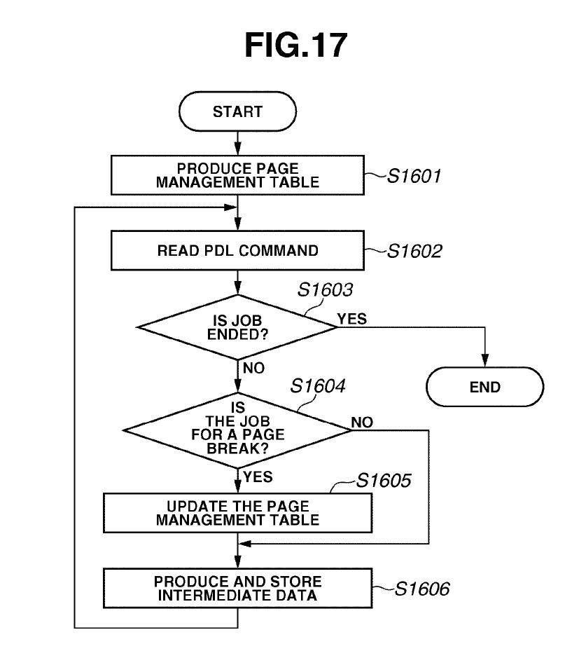

FIG. 17 is a flow chart illustrating an example of a processing executed by the translator 1502.

First, in step S1601, as an initialization processing, the page management table 1505 is produced.

Then, in step S1602, the PDL command stored in the receiving buffer 1501 is read. Then, in step S1603, whether the job is completed is determined. If it is determined that the job is completed (“Yes” in step S1603), the processing ends. On the other hand, if the job is not completed (“No” in step S1603), the processing advances to step S1604 where it is determined whether or not the job is for a page break.

If it is determined that the job is for a page break (“Yes” in step S1604), the processing advances to step S1605 where the translator 1502 updates the page management table 1505 so that the PDL data of the next page can be processed. More specifically, the processing in steps S1602 through S1605 is repeated so as to produce the intermediate data 1506 for one page, and then a flag indicating that the PDL command is received is set to be on in a portion of the page management table 1505 corresponding to that page.

On the other hand, if the job is not for a page break (“No” in step S1604), the processing skips step S1605 and advances to step S1606.

In step S1606, the intermediate data is produced from the PDL command, and then the produced intermediate data is stored in the RAM 213.

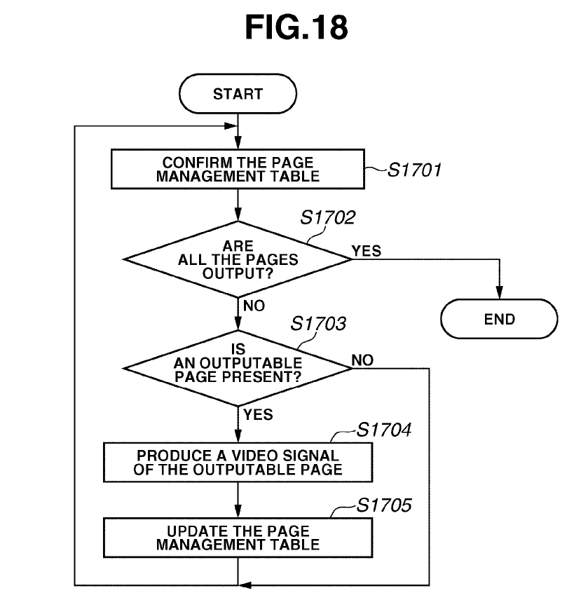

FIG. 18 is a flow chart illustrating an example of a processing executed by the renderer 1503. In an embodiment, the renderer 1503 operates in a separate process independent of the translator 1502, and the renderer 1503 is activated when the translator 1502 stores the intermediate data 1506 for one page in the RAM 213.

First, in step S1701, the page management table 1505 is confirmed. Next, in step S1702, it is determined whether there is a page to be processed (output) based on the result of the confirmation of the page management table 1505. If it is determined that there is no page to be processed (“Yes” in step S1702), the processing ends. On the other hand, if there is a page to be processed (“No” in step 1702), the processing advances to step S1703 where it is determined whether an outputable page is present on the basis of the result of the confirmation of the page management table 1505.

If it is determined that there is an outputable page (“Yes” in step S1703), the processing advances to step S1704. In step S1704, the processing for rasterizing the intermediate data of the outputable page into image data (for example, a bitmap image) is performed. Then, the image data is converted into a video signals. The video signal is sent to the printer engine 216. The printer engine 216 performs printing based on the video signal and discharges the printed paper sheet.

Next, in step S1705, a signal indicating that the corresponding page is already output (printed) is recorded in the page management table 1505. More specifically, a flag indicating that the printing is completed is set to be on in a portion of the corresponding page in the page management table 1505.

If it is determined that there is no outputable page in step S1703, the processing skips steps S1704 and S1705 and returns to step S1701. Then, the processing waits until the translator 1502 produces the intermediate data of the outputable page and updates the page management table 1505. As described above, the processing repeats steps S1701 through S1705 until there is no page to be processed (output).

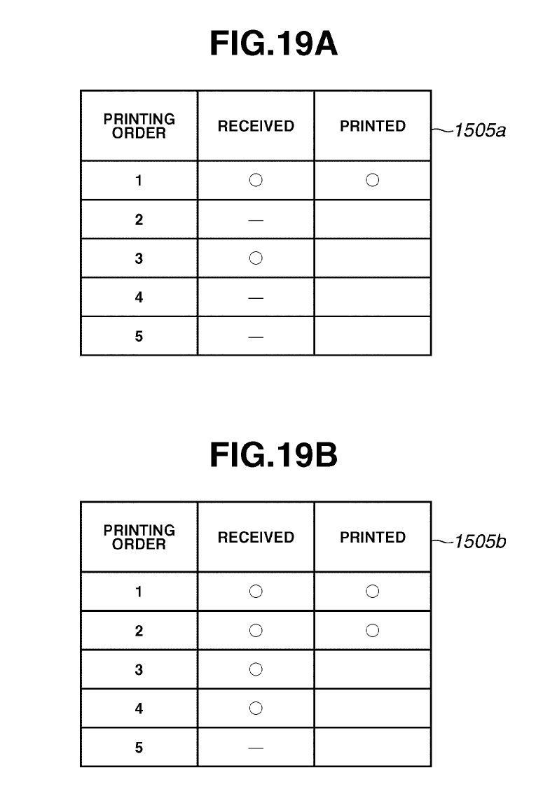

FIG. 19A and FIG. 19B are schematic diagrams each illustrating an example of a configuration of the page management table 1505.

Referring to FIGS. 19A and 19B, page management tables 1505a and 1505b are tables configured by a “printing order” flag, a “received” flag, and a “printed” flag as one set. The set of flags is produced in the same number as the pages to be output.

The “printing order” flag indicates the order of outputting of the page numbers stored in the page start command within the print data 1300 produced by the PDL processor 2005 and the PDL processor 2006. In an ordinary printing occasion, the values of “1, 2, 3, . . . ” are entered in the “printing order” column and the printing is performed in accordance with the order sent from the application program 32. However, in performing a bookbinding printing, a two-sided printing, or a reverse-order printing, the values of the printing order are changed at the time of initialization.

The “received” flag is a flag that is set to be on in step S1605 when the translator 1502 completes the production of the intermediate data 1506 for one page. The “printed” flag is a flag that is set to be on when the renderer 1503 completes the output.

The page management table 1505a shown in FIG. 19A indicates that the first page and the third page are already received and only the first page is already output (printed) In this state, the intermediate data of the third page has already been produced, but the second page that is to be output (printed) next is not yet received. Thus, the second page cannot be output (printed).

The page management table 1505b shown in FIG. 19B indicates a state where the processing has advanced from the state indicated in the page management table 1505a shown in FIG. 19A. That is, in the page management table 1505b, not only the intermediate data of the first page and the third page has been produced but also the intermediate data of the second page and the fourth page has been produced, the printing of the second page is also completed, and the print processing of the third page is now being performed.

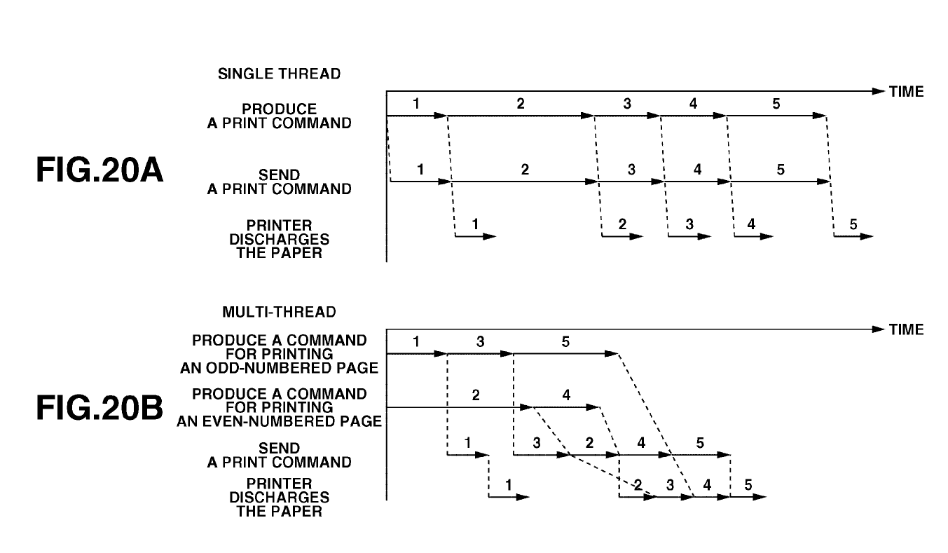

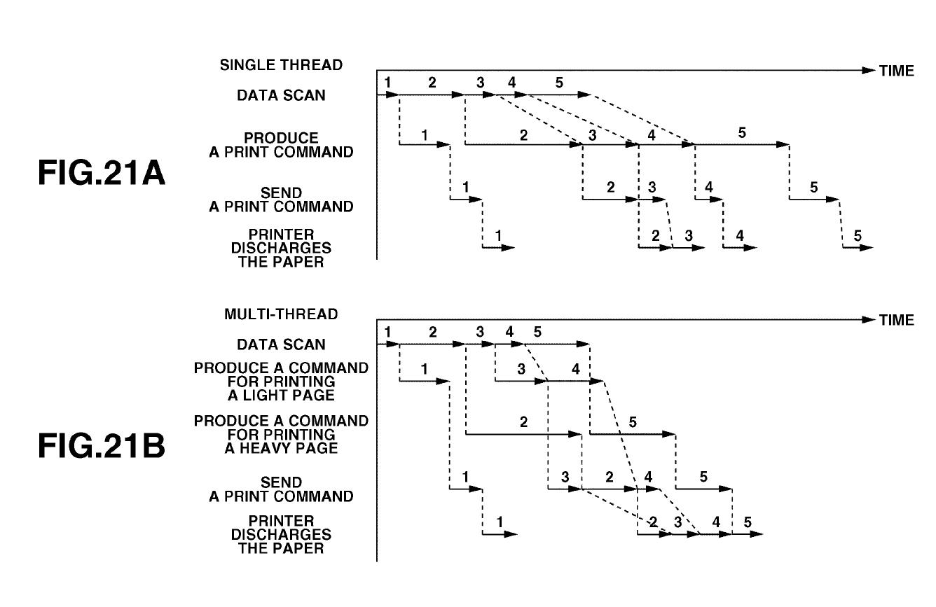

Next, effects of the first embodiment are described with reference to FIGS. 20A, 20B, 21A, and 21B. FIGS. 20A and 20B are diagrams respectively illustrating the processing time in the case of processing by a conventional single thread and the processing time in the case of processing by multi-thread (two threads including a thread corresponding to odd-numbered pages and a thread corresponding to even-numbered pages) according to the first embodiment.

FIG. 20A is a schematic diagram illustrating the time taken when the print command is produced in the conventional single thread by the printer driver sending the print command in order of input of the print jobs, the time taken when the print command is sent by the printer driver in order of input of the print jobs, and the time taken when the printer discharges the paper.

Referring to FIG. 20A, among the print jobs of continuous five pages, the print jobs of the second page and the fifth page require a longer time in producing the print data thereof. Thus, the time taken for sending the print command for the second page and the fifth page is longer than the time taken for sending the print command for the first page, the third page and the fourth page, and the printer waits during that time.

FIG. 20B is a schematic diagram illustrating the processing time taken in the case where the same print jobs as shown in FIG. 20A are processed in the method according to the first embodiment.

In the example shown in FIG. 20B, the processing capacity of the PDL processor 2005 is generally the same as the PDL processor 2006. In an embodiment, the spool file manager 2004 does not switch the processing mode based on a processing load of the pages but allocates the print processing to the PDL processor 2005 and the PDL processor 2006 in order of input, for example, in an alternating manner. In the example of FIG. 20B, two PDL processors are provided. However, it is noted that embodiments of the present invention can be implemented with any suitable number of PDL processors. For example, in the case where three PDL processors are provided, a first PDL processor produces the print command of the page having a page number of a multiple of 3 minus 2 (e.g., 1, 4, 7, 10, etc.), a second PDL processor produces the print command of the page having a page number of a multiple of 3 minus 1 (e.g., 2, 5, 8, 11, etc.), and a third PDL processor produces the print command of the page having a page number of a multiple of 3 (e.g., 3, 6, 9, 12, etc.).

In FIG. 20B, while a long time is taken in producing the print command of the second page that is an even-numbered page, the production of the print command of the first and the third pages that are odd-numbered pages is completed. Therefore, the print command of the third page is sent to the printer 2 before the print command of the second page is sent.

The print command cannot be sent to the printer 2 before it is produced. However, with the above configuration, a transfer path between the information processing apparatus 1 and the printer 2 can be effectively used so as to reduce the time during which the printer 2 is in a waiting state.

FIGS. 21A and 21B are diagrams illustrating the processing time in the case of processing by the conventional single thread and the processing time in the case of the multi-thread (two threads including a thread for a low processing load page and a thread for a high processing load page) according to the first embodiment.

As shown in FIG. 21A, conventionally, the print command is produced by one thread. Therefore, when a high processing load page which takes a long time in processing is present among the print jobs and the high processing load page is rasterized into the image data by the printer driver, the print command (print data) is not sent to the printer during that time. Thus, the treatment efficiency of the entire processing becomes low.

On the contrary, if the print command is produced by sharing the processing by a PDL production thread for a low processing load page and a thread dedicated to the image mode for a high processing load page, the print command of the low processing load page can be produced and sent to the printer 2 while the high processing load page is being processed. Thus, the resource of both the information processing apparatus 1 and the printer 2 can be effectively used so as to shorten the total time taken for printing.

As described above, in the first embodiment, a plurality of processing threads are provided for each processing mode of the print data, and the PDL processor 2005 and the PDL processor 2006 process the plurality of processing threads in parallel so as to produce the print data file 2010. Then, immediately after the print data file 2010 is produced, the print data included in the print data file 2010 is output to the printer 2. Thus, the communication path between the information processing apparatus 1 and the printer 2 can be effectively used and the time during which the printer 2 does not perform a processing can be reduced. Thus, the total processing time taken for printing can be shortened.

Note that in the first embodiment, the printing is performed in order of pages by rearranging the print data sent from the information processing apparatus 1 in order of production, upon determining whether the outputable page is present on the basis of the result of confirmation of the page management table 1505. However, the configuration may be such that the information processing apparatus 1 sends the produced print data to the printer 2 in order of printing so as to allow the printer 2 to perform the print processing of the print data in order of receiving the print data.

Second Exemplary Embodiment

A second embodiment of the present invention is described below. In the first embodiment described above, the OS sends the print command one by one, as in Windows (registered trademark) 2000/XP. However, in the second embodiment, the application program or the OS sends the print command in a bundled form such as a file. That is, the second embodiment is different from the first embodiment described above in a part of the processing of the print command. Therefore, in the description of the second embodiment, the portions that are similar to those of the first embodiment are provided with the same reference numerals and symbols shown in FIGS. 1 through 21, and a detailed description thereof is omitted.

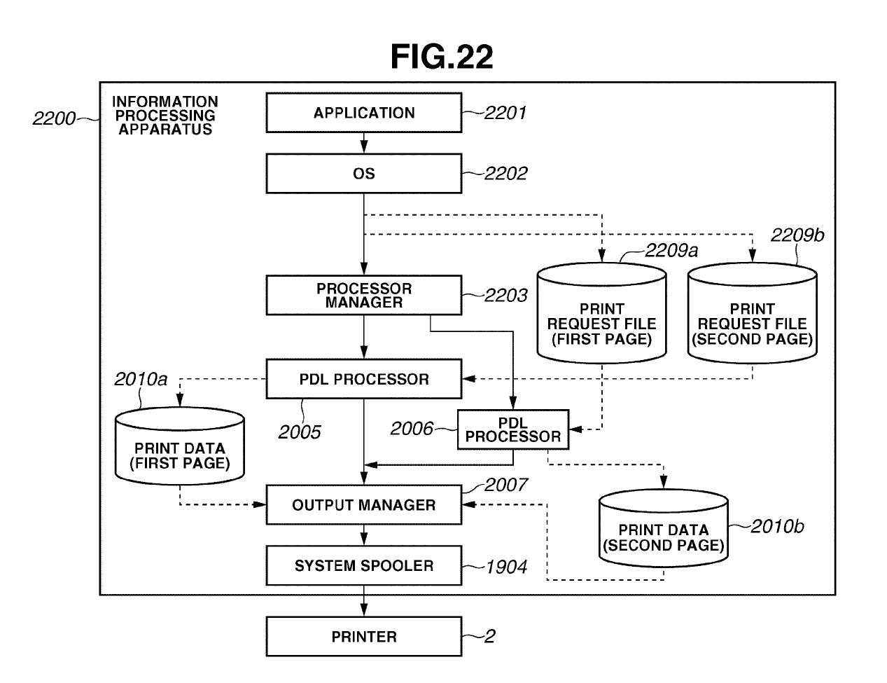

FIG. 22 is a diagram illustrating an example of a configuration of the print processing by an information processing apparatus 2200 according to the second embodiment.

Referring to FIG. 22, a processor manager 2203 starts the processing upon receiving a print request file 2209 produced by an application program 2201 or an OS 2202. Note that the application program 2201 and the OS 2202 according to the second embodiment and the application program 32 and the OS 36 according to the first embodiment are similar except in the point that the print command is sent in the form of a file by the print request file 2209.

The processor manager 2203 analyzes the received print request file 2209 and determines the processing mode.

The processor manager 2203 reads the PDL processor 2005 and the PDL processor 2006 corresponding to the determined processing mode from the HD drive 203 and loads them to the RAM 202. Then, the processor manager 2203 instructs the PDL processor 2005 and the PDL processor 2006 to perform the print processing of the intermediate code written in the print request file 2209.

The PDL processor 2005 and the PDL processor 2006 operate in different processes or in different threads. In the second embodiment, the PDL processor 2005 is a module for producing a print data file 2010 that is related to the PDL having high abstractness, and the PDL processor 2006 is a module for producing a print data file 2010 that is related to the intermediate data having low abstractness.

The PDL processor 2005 and the PDL processor 2006 process the print request file 2209 designated by the processor manager 2203 so as to produce a print data file 2210 for one page.

Then, after producing (spooling) the print data file 2010 for one page, the PDL processor 2005 and the PDL processor 2006 sends the print data file 2010 to an output manager 2007, which operates in a separate process.

The output manager 2007 outputs the received print data file 2010 to the printer 2 via a system spooler 1904.

Thus, the second embodiment is different from the first embodiment in the manner of sending the print command by the OS, depending on an environment in which the OS operates. However, if the print command is segmented into regions and the print data (the print data file 2010) is produced in a plurality of threads, the same effect as the first embodiment can be obtained.

Note that in each embodiment described above, the medium that stores the print-related module including the control program that performs the above processing is the FD 206 or the HD drive 203. However, in addition to these, a CD-ROM and an IC memory card can be applied. In addition, the configuration may be such that the control program only or the print-related module including the control program is stored in the ROM 205 to form a part of the memory map so as to allow the CPU 201 to directly execute the control program.

Third Exemplary Embodiment

A third embodiment of the present invention is described below.

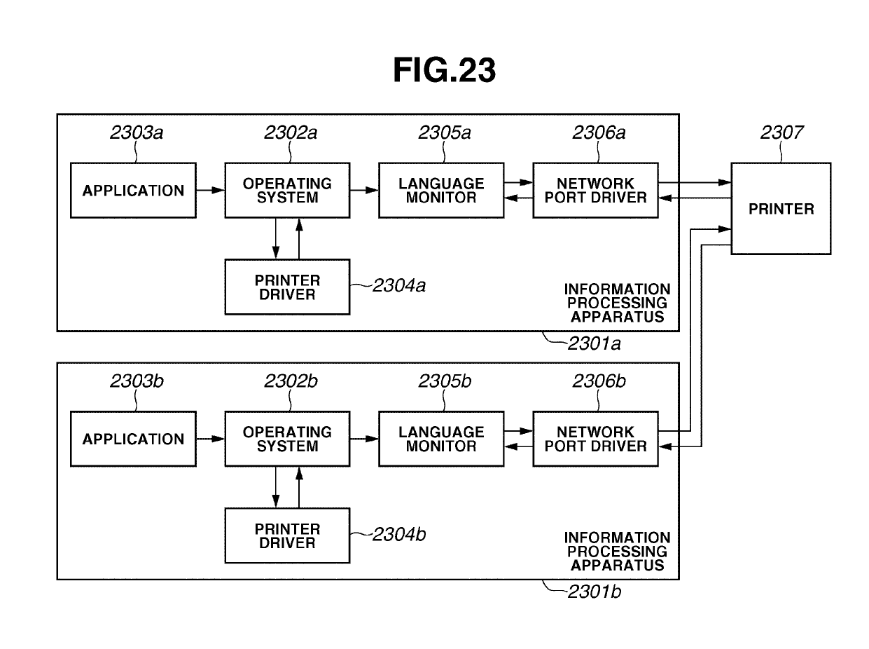

FIG. 23 is a block diagram illustrating an example of a configuration of an information processing apparatus according to the third embodiment.

Referring to FIG. 23, an information processing apparatus 2301 (2301a or 2301b) is a computer. The information processing apparatus 2301 includes hardware in a common information processing apparatus such as a CPU, a memory, a hard disk, a flexible disk drive, a keyboard, a mouse, a display, and a network interface. That is, a hardware configuration of the information processing apparatus 2301 is, for example, as shown in FIG. 2.

An example of a software configuration of the information processing apparatus 2301 is described below. An operating system (OS) 2302 (2302a or 2302b) manages hardware equipped to the information processing apparatus (client) 2301 and software such as an application program 2303 (2303a or 2303b), a printer driver 2304 (230a or 2304b), a language monitor 2305 (2305a or 2305b), and a network port driver 2306 (2306a or 2306b) . For a representative operating system, there is, for example, Windows (registered trademark) of Microsoft Corporation.

The application program 2303 has a function for producing a document and rendering a figure and editing the same, just as a word processor, and a function for editing a photographic image. In addition, the application program 2303 can issue a print instruction based on application data produced and edited by the application program 2303.

The printer driver 2304 receives the print instruction issued by the application program 2303 via the OS 2302. Then, the printer driver 2304 converts the received print instruction into a printer command that can be interpreted by either one of the language monitor 2305 and a printer 2307.

The language monitor 2305 receives the printer command output from the printer driver 2304 and sends the received printer command to the printer 2307 via the network port driver 2306. In a client computer-based printing system, it is necessary that the printer command is sent in accordance with the state of printing by the printer 2307 while receiving a detailed status of the printer 2307. The processing for sending the printer command in this manner in accordance with the printing state of the printer 2307 is performed by the language monitor 2305. In a PDL type printing system, the load of the processing is more or less reduced.

The network port driver 2306 sends the printer command output from the language monitor 2305 to the printer 2307 via the above network interface. In addition, the network port driver 2306, upon receiving the status of the printer 2307 from the printer 2307, outputs the status of the printer 2307 to the language monitor 2305. The printer 2307 performs various processings related to printing in accordance with the printer command received from the network port driver 2306.

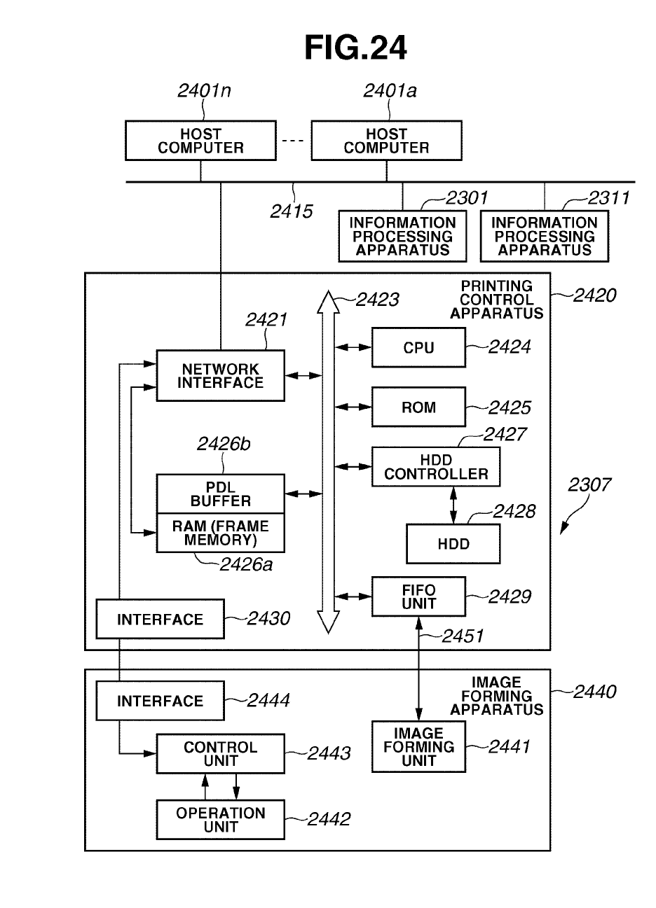

FIG. 24 is a block diagram illustrating an example of a configuration of a printing control apparatus according to the third embodiment. Referring to FIG. 24, a plurality of host computers 2401a through 2401n are connected to a network 2415. A printing control apparatus 2420 is a controller that performs a defined image processing on image data sent from the plurality of host computers 2401a through 2401n via an interface (a network interface 2421). An image forming apparatus 2440 is connected to the printing control apparatus 2420 and prints out a color/gray-scale digital image, for example. Thus, a printer 2307 (shown in FIG. 23) is configured by the printing control apparatus 2420 and the image forming apparatus 2440.

The printing control apparatus 2420 includes the network interface 2421 for connection to the host computers 2401a through 2401n, and the network interface 2421 is connected to a CPU bus 2423. A CPU 2424, a ROM 2425, an RAM 2426, an HDD controller 2427, a RAM 2426 (2426a and 2426b), and a first-in first-out (FIFO) unit 2429 are connected to the CPU bus 2423.

The CPU 2424 controls the operation of the printing control apparatus 2420. The ROM 2425 stores the control program that is executed when the CPU 2424 controls the operation of the printing control apparatus 2420. The RAM 2426 is used as a work area when the CPU 2424 executes the control program.

An internal hard disk (HD) 2428 stores font data and a password to be described below. The HDD controller 227 controls the operation of the internal hard disk (HD) 2428.

The RAM 2426 includes a frame memory 2426a that stores raster image data and a PDL buffer 2426b that retains PDL image data. Note that the raster image data can be stored in the internal HD 2428 instead of being stored in the frame memory 2426a.

In addition, the network interface 2421 itself includes a CPU in its inside and is provided with an intelligent capacity for independently performing the control of the network 2415.

According to the printing control apparatus 2420 having the above configuration, the PDL image data that is sent from the host computer 2402 via the network interface 2421 is temporarily retained in the PDL buffer 2426b via the CPU bus 2423. The CPU 2424 rasterizes the PDL image data retained in the PDL buffer 2426b into raster image data by using the font data stored in the ROM 2425 or the internal HD 2428 and writes the raster image data into the frame memory 2426a.

The raster image data is sent as an image forming signal 2451 from the printing control apparatus 2420 to the image forming apparatus 2440 via the CPU bus 2423 and the FIFO unit 2429. In the image forming apparatus 2440, an image is formed on the basis of the image forming signal 2451. In addition, the printing control apparatus 2420 and the image forming apparatus 2440 are capable of performing various communications via interfaces 2430 and 2444.

In addition, the network interface 2421 can directly access the frame memory 2426a for rendering. More specifically, the data can be directly transferred from the network interface 2421 to the frame memory 2426a for rendering by using simple hardware with a direct memory access (DMA).

The image forming apparatus 2440 includes an image forming unit 2441, an operation unit 2442, a control unit 2443, and the interface 2444. The image forming unit 2441 has a function for outputting the image data sent from the host computers 2401a through 2401n to a recording medium in a colored form or in a gray scale with a resolution of 400 dpi, for example.

The control unit 2443 controls the operation of the image forming apparatus 2440. The control unit 2443 has a function for printing an image in accordance with the content of an operation on the operation unit 2442 having a button and a switch by a user and in accordance with the content of the communication with the printing control apparatus 2420.

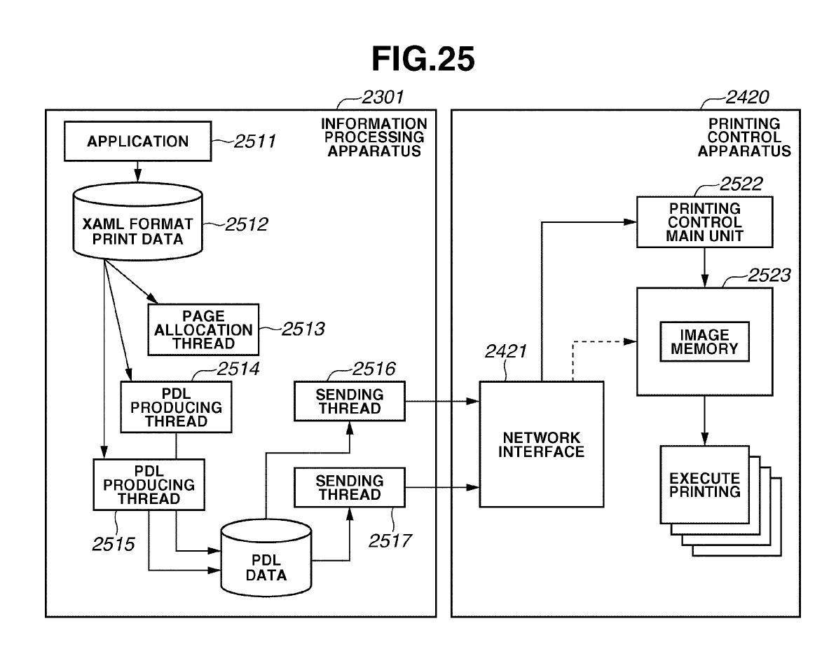

FIG. 25 is a block diagram illustrating an example of a functional configuration of the information processing apparatus 2301 and the printing control apparatus 2420 according to the third embodiment. The information processing apparatus 2301 and the printing control apparatus 2420 are mutually connected via a network. An example of an operation of an image processing system in performing the print processing is described below.

An application program 2511, when a print operation is started, produces print data 2512 in an XAML format. The XAML print data 2512 produced in this case is the same as the conventional print data of a graphic device interface (GDI) format. When the XAML print data 2512 is produced, a page allocation thread 2513 analyzes the print data 2512. Then, considering the content of the processing and a parallel processing performance, the page allocation thread 2513 segments the print data 2512 into regions and allocates the segmented print data 2512 to PDL producing threads 2514 and 2515.

When the print data 2512 is allocated, the PDL producing threads 2514 and 2515 produce PDL data based on the allocated print data. The PDL producing threads 2514 and 2515 perform the processing for producing the PDL data in parallel. Note that the PDL producing threads 2514 and 2515 can send the data rasterized into image data by the host computer 2401 to the printing control apparatus 2420, in addition to the PDL data.

The PDL data produced by the PDL producing threads 2514 and 2515 is sent to the printing control apparatus 2420 via sending threads 2516 and 2517. The processing for sending the PDL data is performed using a network communication channel that is scheduled by the page allocation thread 2513.

The network interface 2421 of the printing control apparatus 2420 determines whether to transfer the received print data to a printing control main unit 2522 or to directly write the received print data to an image memory 2523, in accordance with the kind of the print data. The network interface 2421, if the print data is the PDL data, for example, determines to transfer the print data to the printing control main unit 2522. On the other hand, if the print data is the data rasterized into image data by the host computer 2401 or the data to be subjected to a simple image processing by the network interface 2421, the network interface 2421 determines to directly write the print data to the image memory 2523.

The PDL data transferred to the printing control main unit 2522 is, after being subjected to the image processing by the printing control main unit 2522, written to the image memory 2523. Then, the printing is performed under the control of a printer engine (the image forming apparatus 2440) by the printing control main unit 2522.

The print data directly written from the network interface 2421 to the image memory 2523 is either the data rasterized into the image data by the host computer 2401 or the data that is subjected to a simple image processing by the network interface 2421. In the case of such print data, the resulting data after the simple image processing by the network interface 2421 is written to the image memory 2523 (not via the printing control main unit 2522). Then, the printing is performed under the control of a printer engine (the image forming apparatus 2440) by the printing control main unit 2522.

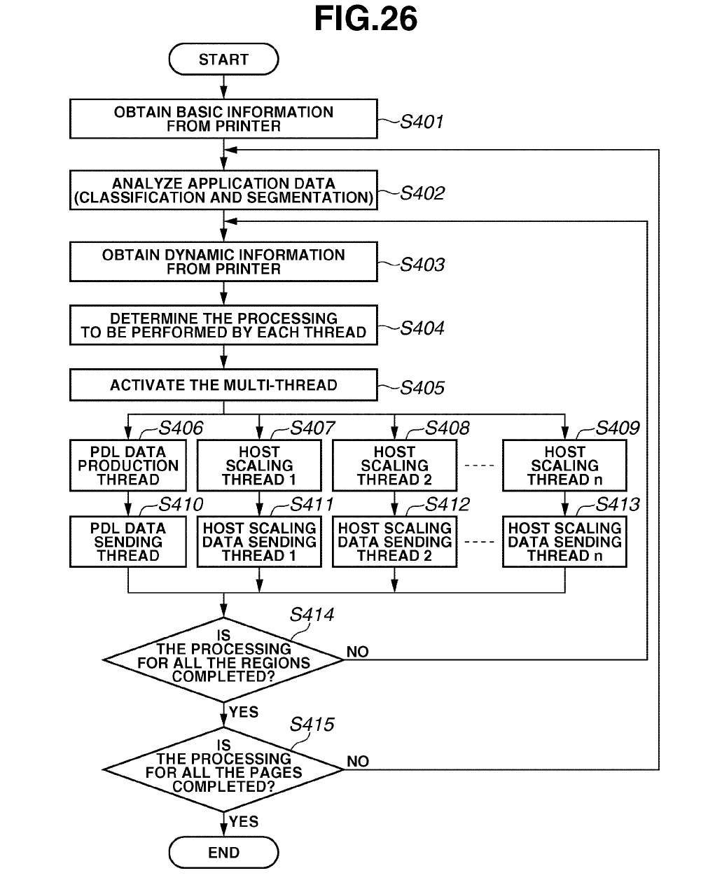

FIG. 26 is a flow chart illustrating an example of the processing by the printer driver 2304 in the information processing apparatus 2301.

First, when the printing operation starts in step S401, basic information is obtained from the printer 2307 that performs printing. The basic information includes static information such as a capacity of the memory for image forming of the printer 2307, information of the CPU 2424 that configures the printing control main unit 2522, and a capacity of a buffer memory that the network interface 2421 can use, for example. The printer driver 2304 switches the processing that the printer driver 2304 performs in accordance with the basic information.

Then, in step S402, the print data (application data) output from the application program 2303 is analyzed. Then, the print data is classified so that the printing time can be effectively shortened, on the basis of the result of the analysis and the static basic information obtained in step S401. The classification of the print data enables a parallel processing of the classified data by using the multi-thread in the information processing apparatus 2301, with the load between the information processing apparatus 2301 and the printing control apparatus 2420 being well distributed.

Next, in step S403, dynamic information that dynamically varies is obtained. The dynamic information includes an actual free space of the memory for image forming, information of load on the CPU 2424, and information of status and progress of printing.

Next, in step S404, the processing to be shared by each thread is determined, and in step S405, the multi-thread that shares the processing is activated. Note that in addition to the processing to be shared, a channel to be used in a sending processing described below is determined in step S404.

Then, in steps S406 through S409, some image processings are performed in parallel so as to produce PDL data and host scaling data. In addition, in steps S410 through S413, the PDL data and the host scaling data are sent in parallel to the printing control apparatus 2420 via the network 2415 using the multi-thread.

Then, in step S414, whether the processing is completed for all the regions of one page is determined. If, as a result of the determination, it is determined that the processing is not completed for all the regions of one page, the processing returns to step S403 and repeats steps S403 through S414 until the processing is completed for all the regions of one page.

When the processing is completed for all the regions of one page, the processing advances to step S415. Instep S415, whether the processing is completed for all the pages is determined. If, as a result of determination, it is determined that the processing is not completed for all the pages, the processing returns to step S402 and performs the processing for the next page, thus repeating steps S402 through S415 until the processing is completed for all the pages. When the processing is completed for all the pages, the printing processing ends.

Note that in the above description, one page is segmented into several regions, and the segmented regions are processed by multi-thread on a shared basis. However, the segmentation may be performed on an object basis, not on a region basis. In this case, for example, it is necessary that the order of superposing the objects is considered by using information on the superposition of objects and that a layout of each page is considered by using page information.

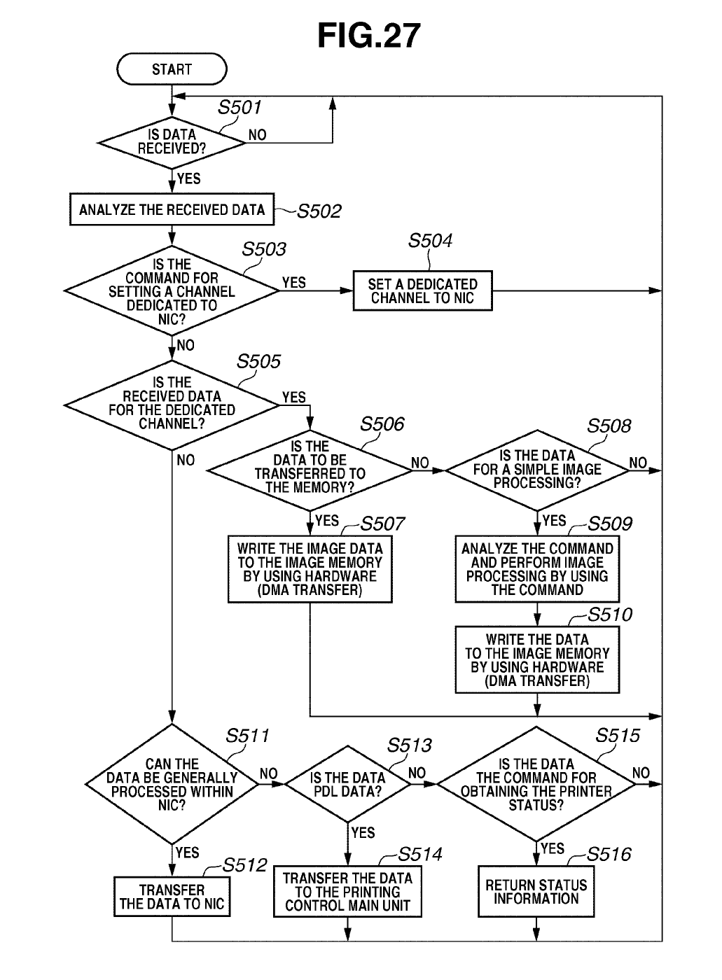

FIG. 27 is a flow chart illustrating an example of the processing by the network interface 2421 in the printing control apparatus 2420.

First, in step S501, the processing waits until data is received from the network 2415. When data is received, the processing advances to step S502. In step S502, a protocol of the received data is analyzed to analyze the content of the data. The received data usually has a description in the form of a certain command.

Then, in step S503, whether the received data is a command for setting a channel dedicated to a network information card (NIC) used in printing is determined.

If, as a result of the determination, it is determined that the received data is a command for setting a channel dedicated to the NIC used in printing, then information on a channel to be used thereafter is specified, and thus the processing advances to step S504.

Then, in step S504, a dedicated channel is set so that the channel can be used, and after that, the processing returns to step S501 to advance to the next packet processing.

More specifically, in step S504, the processing listens with respect to a transmission control protocol (TCP) port having a certain number.

In addition, the command for setting a channel dedicated to the NIC used for printing includes a specification of a function that the NIC performs. Therefore, the processing based on the specified function is performed on the data received by the NIC.

On the other hand, if the received data is not the command for setting the channel dedicated to the NIC used for printing, the processing advances to step S505 to determine whether the received data is the print data for the dedicated channel set in step S504. If, as a result of the determination, it is determined that the received data is the print data for the dedicated channel set in step S504, the processing is performed by using the function provided to the dedicated channel (step S506 through S510) . Here, a memory transfer processing and a simple image processing are described.

In step S506, whether the received data is the data for memory transfer processing is determined. If it is determined that the received data is the data for memory transfer processing, the processing advances to step s507 to perform the memory transfer processing. In the memory transfer processing, the image data included in the received data is directly written into a memory area (the image memory 2523) based on image memory address information included in the received data. In this manner, by enabling the writing of the image data without using the CPU 2424 that configures the printing control main unit 2522, an increase of the load on the CPU 2424 can be avoided.

In step S506, if the received data is not the data for the memory transfer processing, the processing advances to step S508 to determine whether the received data is the data for the simple image processing. If the received data is the data for the simple image processing, the processing advances to step S509 to perform the simple image processing. In the simple image processing, the command of the received data is analyzed and the image processing according to the result of the analysis is performed. For example, the compressed data is decompressed. Then, in step S510, the data subjected to the image processing in step S509 is written to the image memory 2523. By allowing the network interface 2421 to perform the image processing that the CPU of the NIC can perform, the amount of image data to be transferred can be reduced so as to improve the communication speed, and thus an increase of the load on the CPU can be avoided.

If it is determined in step S505 that the received data is not the print data for the dedicated channel set in step S504, the processing advances to step S511. In step S511, whether the received data is the data that can be processed within the NIC is determined. For example, whether the received data is a Management Information Base (MIB) is determined. If the received data is determined to be the data that can be processed within the NIC, the processing advances to step S512. In step S512, the received data is transferred to the NIC, and necessary data is output to the NIC upon receiving a request from the NIC.

On the other hand, if the received data is not the data that can be processed within the NIC, the processing advances to step S513 to determine whether the received data is PDL data. If the received data is determined to be PDL data, the processing advances to step S514. In step S514, the received data is transferred to the printing control main unit 2522.

On the other hand, if the received data is not PDL data, the processing advances to step S515 to determine whether the received data is a command for obtaining status information of the printer 2307. If the received data is determined to be the command for obtaining the status information of the printer 2307, the processing advances to step S516. In step S516, the communication with the printing control main unit 2522 is performed to obtain the dynamic information that dynamically varies, and the obtained dynamic information is returned to the information processing apparatus 2301.

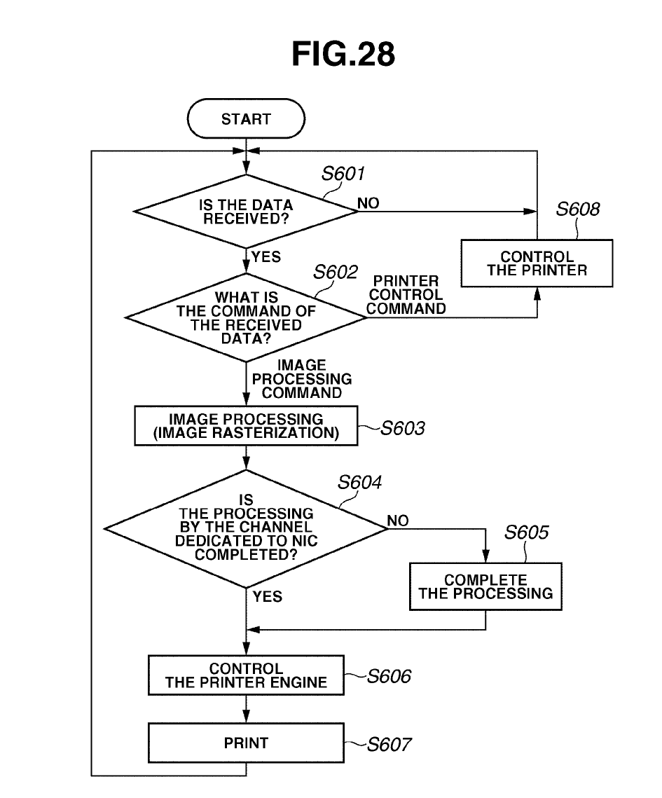

FIG. 28 is a flow chart illustrating an example of the processing by the printing control apparatus 2420.

First, in step S601, the network interface 2421 waits until data is received from the network 2415. When data is received, the processing advances to step S602. In step S602, the network interface 2421 analyzes the received data. Then, whether the received data is an image processing command or a printer control command is determined.

If the received data is determined to be the image processing command, the processing advances to step S603. In step S603, the printing control main unit 2522 or the network interface 2421 performs the processing in accordance with whether the received data is the data for memory transfer processing or the data for the simple image processing. Then, finally, the received data is rasterized into image data by using the image memory 2523. Then, the rasterized image data is printed.

Next, in step S604, the network interface 2421 determines whether the processing by the channel dedicated to the NIC is completed. If the processing by the channel dedicated to the NIC is not completed, the processing advances to step S605. In step S605, the network interface 2421 performs control by waiting so that a final printing processing is completed.

Next, in step S606, the printing control main unit 2522 performs printing under the control of the printer engine (the image forming apparatus 2440).

If the received data is determined to be the printer control command in step S602, the processing in accordance with the received printer control command such as setting of the printer 2307 and the returning of the status information of the printer 2307 is performed in step S608, and then the processing returns to step S601.

As described above, in the third embodiment, the information processing apparatus 2301 segments the region of the print data in accordance with the result of the analysis of the print data output from the application program 2303 and the basic information obtained from the printer 2307 and classifies the segmented print data. Then, the information processing apparatus 2301 determines the processing shared by each thread of the multi-thread based on the dynamic information obtained from the printer 2307. Each thread performs the determined processing in parallel to each other, and produces the PDL data and the host scaling data (for example, the data for the memory transfer processing and the data for the simple image processing). Then, the produced PDL data and the host scaling data are sent in parallel to the printer 2307 by using a plurality of channels. With the above configuration, the print data can be effectively produced by the information processing apparatus 2301 so as to shorten the time required for printing.

In addition, the network interface 2421 of the printing control apparatus 2420 of the printer 2307, when the print data sent from the information processing apparatus 2301 is the PDL data, transfers the print data to the printing control main unit 2522. Then, the printing control main unit 2522 performs the image processing. On the other hand, when the print data sent from the information processing apparatus 2301 is the host scaling data such as the data rasterized into image data by the host computer 2401, the network interface 2421 performs the image processing of the data. With the above configuration, the print data produced by the information processing apparatus 2301 can be effectively sent and received so as to shorten the time required for printing.

Other Embodiments

The aspect of the present invention can also be achieved by providing a system or a device with a storage medium which records program code of software implementing the functions of the above-described embodiments and by reading and executing the program code stored in the storage medium with a computer of the system or the device (a CPU or a MPU).

In this case, the program code itself, which is read from the storage medium, implements the functions of the embodiments, and accordingly, the storage medium storing the program code constitutes the present invention. As the storage medium for supplying such program code, a floppy disk, a hard disk, an optical disk, a magneto-optical disk, a CD-ROM, a CD-R, a magnetic tape, a nonvolatile memory card, a ROM, and the like can be used.

In addition, the functions according to the embodiments described above can be implemented not only by executing the program code read by the computer, but also implemented by the processing in which an OS (operating system) or a combination of the OS and other application software carries out a part of or the whole of the actual processing on the basis of the instruction given by the program code.

Further, in another aspect of the embodiments of the present invention, after the program code read from the storage medium is written in a memory provided in a function expansion board inserted in a computer or a function expansion unit connected to a computer, a CPU and the like provided in the function expansion board or the function expansion unit can carry out a part of or the whole of the processing to implement the functions of the embodiments described above.

According to an exemplary embodiment of the present invention, if there is a region of a high processing load among the print jobs, the throughput of the print job can be improved. In addition, the sharing of the processing is changed according to the state of the printing apparatus that dynamically varies, and thus the throughput of the print job can be improved.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2005-265908 filed Sep. 13, 2005, which is hereby incorporated by reference herein in its entirety.

What is claimed is:

1. An apparatus comprising:
a plurality of processing units;
an allocation unit configured to allocate data in a plurality of regions included in a print job to the plurality of processing units; and
an output unit configured to output, to a printing apparatus, a plurality of print commands produced by the plurality of processing units subjected to allocation by the allocation unit.

2. The apparatus according to claim 1, wherein the data of each respective one of the plurality of regions included in the print job is allocated to each respective one of the plurality of processing units.

3. The apparatus according to claim 1, wherein the allocation unit allocates the data of each of the plurality of regions in accordance with processing load associated with each of the plurality of regions.

4. The apparatus according to claim 1, wherein the output unit is configured to output, to the printing apparatus, the plurality of print commands produced by the plurality of processing units in order of production regardless of an order of printing.

5. The apparatus according to claim 4, wherein the output unit is configured to output, to the printing apparatus, a print command including information for specifying the order of printing.

6. The apparatus according to claim 1, wherein the plurality of processing units include a plurality of threads.

7. The apparatus according to claim 1, further comprising an identification information adding unit configured to add identification information for identifying an order of printing to the plurality of print commands produced by the plurality of processing units,
wherein the output unit is configured to output, to the printing apparatus, a plurality of print commands having the identification information added thereto by the identification information adding unit in order of production regardless of the order of printing.

8. The apparatus according to claim 1, wherein the region is one of a page or a band.

9. A method for execution in an information processing apparatus having a plurality of processing units, the method comprising:
allocating data in a plurality of regions included in a print job to the plurality of processing units; and
outputting, to a printing apparatus, a plurality of print commands produced by the plurality of processing units.

10. The method according to claim 9, wherein the data of each respective one of the plurality of regions included in the print job is allocated to each respective one of the plurality of processing units.

11. The method according to claim 9, wherein the data of each of the plurality of regions is allocated in accordance with processing load associated with each of the plurality of regions.

12. The method according to claim 9, wherein the outputting includes outputting, to the printing apparatus, the plurality of print commands produced by the plurality of processing units in order of production regardless of an order of printing.

13. The method according to claim 12, wherein the outputting includes outputting, to the printing apparatus, a print command including information for specifying the order of printing.

14. The method according to claim 9, wherein the plurality of processing units include a plurality of threads.

15. The method according to claim 9, further comprising:
adding identification information for identifying an order of printing to the plurality of print commands produced by the plurality of processing units,
wherein the print commands outputted to the printing apparatus include the identification information added thereto in order of production regardless of the order of printing.

16. The method according to claim 9, wherein the region is one of a page or a band.

17. A computer-readable storage medium storing instructions which, when executed by a computer, causes the computer to perform operations comprising:
allocating data in a plurality of regions included in a print job to the plurality of processing units; and
outputting, to a printing apparatus, a plurality of print commands produced by the plurality of processing units.

18. The computer-readable storage medium according to claim 17, wherein the data of each respective one of the plurality of regions included in the print job is allocated to each respective one of the plurality of processing units.

19. The computer-readable storage medium according to claim 17, wherein the data of each of the plurality of regions is allocated in accordance with processing load associated with each of the plurality of regions.

20. The computer-readable storage medium according to claim 17, wherein the outputting includes outputting, to the printing apparatus, the plurality of print commands produced by the plurality of processing units in order of production regardless of an order of printing.

21. The computer-readable storage medium according to claim 20, wherein the outputting includes outputting, to the printing apparatus, a print command including information for specifying the order of printing.

22. The computer-readable storage medium according to claim 17, wherein the plurality of processing units include a plurality of threads.

23. The computer-readable storage medium according to claim 17, wherein the operations further comprises:
adding identification information for identifying an order of printing to the plurality of print commands produced by the plurality of processing units,
wherein the print commands outputted to the printing apparatus include the identification information added thereto in order of production regardless of the order of printing.

24. The computer-readable storage medium according to claim 17, wherein the region is one of a page or a band.
